(19) United States
(12) Patent Application Publication
(10) Pub. No.: US 2026/0119369 A1
(43) Pub. Date: Apr. 30, 2026

(54) ACCELERATED DATA FILTERING IN SAAS MODELS

(71) Applicant: SAP SE, Walldorf (DE)

(72) Inventor: Bingzhuo Li, Hangzhou (CN)

(21) Appl. No.: 18/933,187

(22) Filed: Oct. 31, 2024

(51) Int. Cl. G06F 11/36

(52) U.S. Cl. CPC G06F 11/3608; G06F 11/3684

(57) ABSTRACT

Some embodiments provide a solution to automatically generate test cases to test the quality, functionality, or performance of a software application. A user provides a test intent that describes the purpose of the new test case. The test intent is encoded into a multi-dimensional vector and the multi-dimensional vector is compared against other semantic coding vectors that represent existing test cases. Based on the similarity of the vectors one or more existing test cases are identified as being similar to the test intent. A prompt is generated using the test intent, the existing test cases that are similar, and optionally a file containing a library of methods that may called upon in the new test case. The prompt is provided as into a Large Language Model, which returns software code for the new test case.

### BACKGROUND

Software companies traditionally use a test suite to test and validate the integrity of software applications. The test suite includes a collection of test cases, scripts, and data used to validate the software application. For example, the test suite may be run on production code of the software application. The test suite can be run when change are made to the software application to ensure that the changes made do not interfere with the quality, functionality, and performance standards of the software application.

As software applications mature and change over time, new test cases are created to validate changes in quality, functionality, or performance. While there are existing methods for automatically generating test code, they only generate simple test code. Furthermore, the existing methods cannot adapt well to special writing styles of different projects. Thus, there is a need for improved methods to automatically generate test case for validating the integrity of software applications.

### SUMMARY

In some embodiments, a non-transitory machine-readable medium stores a program executable by at least one processing unit of a device. The program performs the steps of receiving, in a user prompt of a graphical user interface, a test intent in a natural language describing a new test case for a software application, encoding the test intent into a multi-dimensional vector, querying a history case knowledge database containing a plurality of entries to receive at least one entry, wherein each entry in the plurality of entries is associated with a unique existing test case and includes a code snippet of the unique existing test case, a description in the natural language describing the unique existing test case, and a semantic coding vector representing the description, and wherein the semantic coding vector in each of the at least one entry is similar to the multi-dimensional vector, generating a prompt from the at least one entry and the test intent, transmitting the prompt to a Large Language Model (LLM), receiving, from the LLM, a response to the prompt, wherein the response includes a new code snippet, and generating a new test case that includes the new code snippet and the test intent.

In some embodiments, the program further performs the steps of presenting the new test case on the graphical user interface, receiving, in the graphical user interface, an indication that the new test case is accepted, and adding the new test case to a test case database.

In some embodiments, the program further performs the steps generating a new entry based on the new test case and adding the new entry to the history case knowledge database.

In some embodiments, generating the new entry includes generating a new semantic coding vector from the test intent.

In some embodiments, the test intent includes a new name for the new test case and a new description of the new test case.

In some embodiments, embedding the test intent into a multi-dimensional vector includes embedding the new description into the multi-dimensional vector.

In some embodiments, the prompt includes the new description, the at least one entry, and the description in natural language from the plurality of entries.

In some embodiments, the prompt further includes a file containing a library of existing methods to perform specific tasks, wherein the new code snippet calls upon an existing method from the library of existing methods.

In some embodiments, the method comprises receiving, in a user prompt of a graphical user interface, a test intent in a natural language describing a new test case for a software application, encoding the test intent into a multi-dimensional vector, querying a history case knowledge database containing a plurality of entries to receive at least one entry, wherein each entry in the plurality of entries is associated with a unique existing test case and includes a code snippet of the unique existing test case, a description in the natural language describing the unique existing test case, and a semantic coding vector representing the description, and wherein the semantic coding vector in each of the at least one entry is similar to the multi-dimensional vector, generating a prompt from the at least one entry and the test intent, transmitting the prompt to a Large Language Model (LLM), receiving, from the LLM, a response to the prompt, wherein the response includes a new code snippet, and generating a new test case that includes the new code snippet and the test intent.

In some embodiments, a system includes receiving, in a user prompt of a graphical user interface, a test intent in a natural language describing a new test case for a software application, encoding the test intent into a multi-dimensional vector, querying a history case knowledge database containing a plurality of entries to receive at least one entry, wherein each entry in the plurality of entries is associated with a unique existing test case and includes a code snippet of the unique existing test case, a description in the natural language describing the unique existing test case, and a semantic coding vector representing the description, and wherein the semantic coding vector in each of the at least one entry is similar to the multi-dimensional vector, generating a prompt from the at least one entry and the test intent, transmitting the prompt to a Large Language Model (LLM), receiving, from the LLM, a response to the prompt, wherein the response includes a new code snippet, and generating a new test case that includes the new code snippet and the test intent.

The following detailed description and accompanying drawings provide a better understanding of the nature and advantages of various embodiments of the present disclosure.

### BRIEF DESCRIPTION OF THE DRAWINGS

FIG. 1 illustrates a system for automatically generating test cases according to some embodiments.

FIG. 2 illustrates a system for automatically generating test cases according to some embodiments.

FIG. 3 illustrates a workflow for generating a new test case according to some embodiments.

FIG. 4 illustrates an exemplary system 400 for implementing various embodiments described above.

FIG. 5 illustrates an exemplary computer system 500 for implementing various embodiments described above.

FIG. 6 illustrates an exemplary computing device 600 for implementing various embodiments described above.

### DETAILED DESCRIPTION

In the following description, for purposes of explanation, numerous examples and specific details are set forth in order to provide a thorough understanding of the present disclosure. It will be evident, however, to one skilled in the art that various embodiments of the present disclosure as defined by the claims may include some or all of the features in these examples alone or in combination with other features described below, and may further include modifications and equivalents of the features and concepts described herein.

Described herein are techniques automatically generating software code for test cases used to test the quality, functionality, or performance of a software application. In one example, the software code may be in Java programming language. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein. While generating software code for test cases is one example, it is to be understood by those skilled in the art that the infrastructure described herein has many applications where the generative AI may be utilized to automatically generate different types of software code. In some embodiments, the generated test cases may be presented to a user on a graphical user interface of a display to review and edit. Once the test case is approved, it can be added to the test suite. In some examples, the approved test case may be utilized to train the model. Advantages of automatically generating test cases include improving the efficiency of software developers since the software developer would review and modify the automatically generated test case rather than creating it from scratch. This can improve the productivity of the software developers since less time is spent on the generation of test cases.

Embodiments of the present disclosure include receiving a test intent that describes in natural language what the new test case will be testing. The test intent is encoded into a multi-dimensional vector that corresponds to the purpose of the new test case. A test case knowledge database may store entries that correspond to different test cases in the test suite. Each entry may include software code to execute the test case, a description of the test case, and a vector that represents the test case. The multi-dimensional vector can be compared against other vectors in a test case knowledge database to retrieve test cases that are similar to the new test case. The number of test cases retrieved can be predefined. A prompt generator may combine the test intent, the similar test cases retrieved, and a library of methods that may be utilized when creating the new test case. The library of methods may be a single file that includes a database of methods and their corresponding descriptions in natural language. The prompt generated by the prompt generator may be received as input in a Large Language Model (LLM), which in turn produces a result that is the software code that when executed, will perform the new test case. A user may review the software code on a graphical user interface of a display and edit the software code until the user is satisfied. Once satisfied, the new test case may be stored as part of the test suite. In some examples, the new test case may be added to the test case knowledge database and therefore, can be provided as part of the input to the prompt generator in the future.

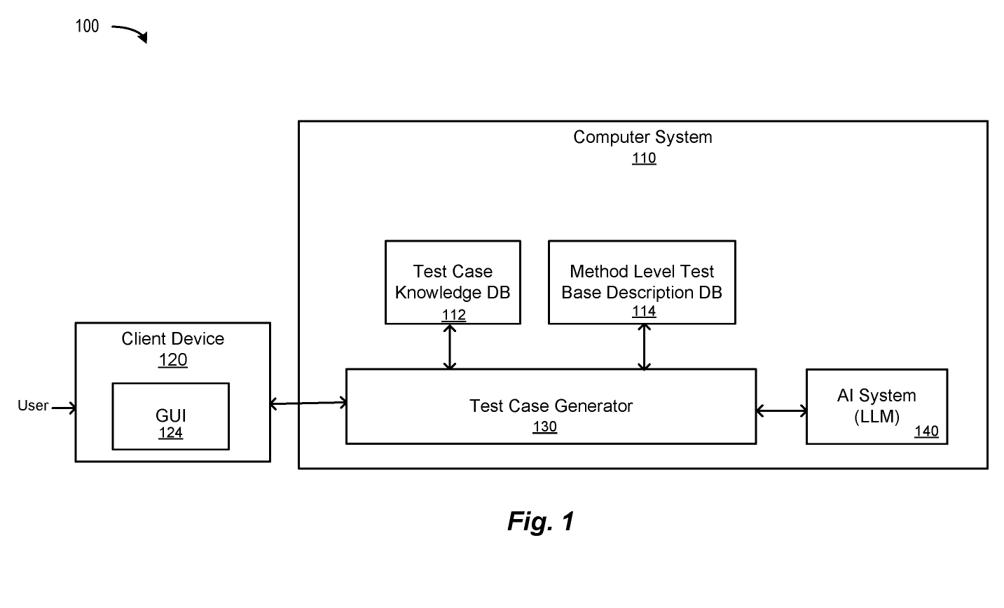

FIG. 1 illustrates a system for automatically generating test cases according to some embodiments. System 100 includes Graphical User Interface (GUI) 124 and computer system 110. In some examples, GUI 124 may be part of a remote terminal on client device 120 that communicates with computer system 110. In other examples, GUI 124 may be a part of computer system 110. Computer system 110 further includes test case generator 130, test case knowledge database 112, method level test base description database 114, and AI system 140. AI system 140 may be a Large Language Model (LLM). The user input may include test intent that describes the intent of the new test case to be automatically generated. For example, id the user wishes to write a new test case to verify that a business value should not be read when the requesting user does not have the corresponding permission, the user may input the test method name for the new test case as "test-business-value-should-not-be-read-if-no-permission."

Test case generator 130 may receive inputs and generate a prompt from AI system 140. In one embodiment, the inputs can include the test intent provided from the user and also test case knowledge database 112. Test case knowledge database 112 includes an entry for each existing test case in the test case library. In one example, all of the test cases used to test a software application may belong to a test suite. Each test case in the test suite may include an entry in the test case knowledge database 112. Test case generator 130 may identify one or more entries in test case knowledge database 112 that are related to existing test cases that are similar to the test intent. These existing test cases may serve as examples to include in the prompt to help refine the results from AI system 140. Once the prompt has been generated, test case generator 130 may transmit the prompt to AI system 140. AI system 140 may receive the prompt as input and in response to the input, generate an output that contains software code for the new test case.

In some embodiments, test case generator 130 may further receive method level test base description database 114. Method level test base description database 114 contains a description of each method in the test base class that can be called. For example, a test base class may include a plurality of methods such as retrieve value, check permissions, or print value. These methods may simplify the programming of the new test case since frequently performed functions do not need to be programmed from scratch but instead call upon methods in the test base class. In one example, the methods in the method level test base description database 114 may be stored in a file and included in the prompt. Including the methods in the prompt may allow the AI system 140 to generate software code that may call upon the methods in the method level test base description database 114. This may be advantageous since it promotes code reuse, which saves time, improves maintainability, and reduces bugs. In some examples, method level test base description database 114 includes a natural language description of the method, the input parameters for the method, the output parameters for the method, and method explanations.

Once AI system 140 generates the software code for the new test case as output, the software code may be presented to the user via GUI 124. A user may review the new test case and make changes as needed. Once the user is satisfied with the new test case, the new test case can be saved as part of the test suite. Technical advantages of system 100 include the ability to automatically generate software code for a test case from a natural language description of the intent of the test case. This reduces the time spent by a developer to create new test cases since time is spent reviewing and editing the automatically generated software code instead of developing software code from scratch.

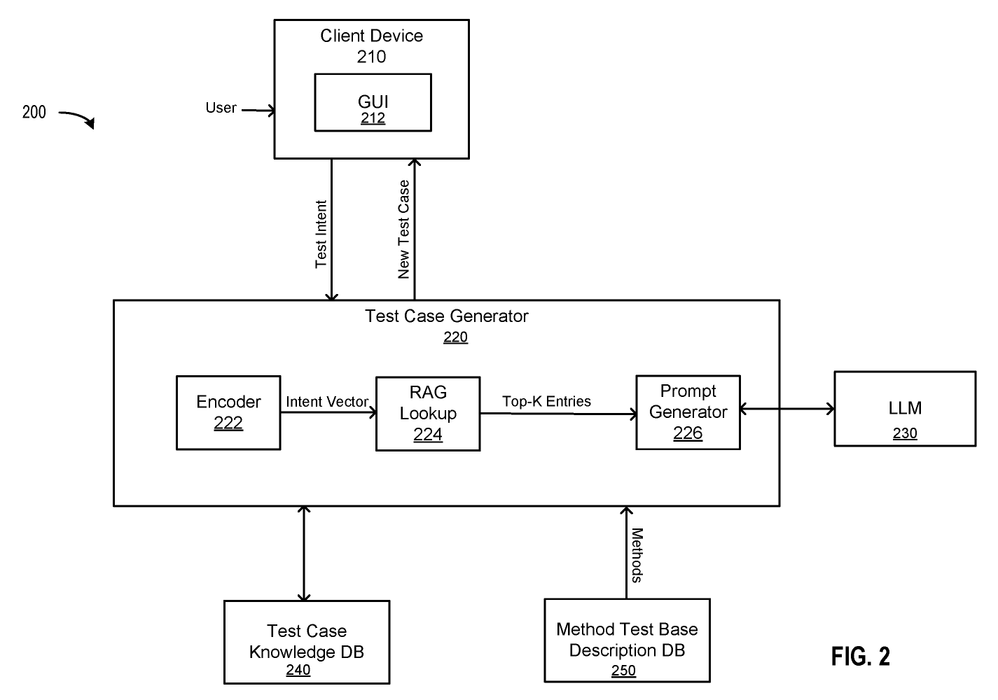

FIG. 2 illustrates a system for automatically generating test cases according to some embodiments. The components in system 200 may belong to one computing system or may be distributed across multiple computing systems. For example, test case generator 220 may reside on a first computing system while test case knowledge DB 240 resides on a second computing system and LLM 230 resides on a third computing system. As shown, system 200 includes client device 210 which includes GUI 212. GUI 212 may be used as an interface for the user or developer of system 200 that wishes to generate a new test case. In one embodiment, the user may provide a test intent, which includes a plurality of parameters that describe the new test case. One parameter may be the name of the new test case. Another parameter may be a description of the new test case. The name and the description may be in natural language. Another parameter may be the input parameters for the new test case. Another parameter may be the return type of the new test case. The number of parameters that are included in the test intent may be dependent on the specific implementation details.

Client device 210 may transmit the test intent to test case generator 220. Test case generator 220 may be configured to generate a new test case that satisfies the parameters within the test intent. Test case generator 220 may include encoder 222, RAG lookup 224 and prompt generator 224. Encoder 222 is configured to encode the test intent into an intent vector. The intent vector is a multi-dimensional vector that represents the test intent. Encoder 222 transmits the intent vector to RAG lookup 224.

Embodiments of the present disclosure may include a retrieval augmented generation (RAG) framework that combines an LLM and a test case knowledge database 240. The LLM may be a neural network that can generate natural language text based on a given input, such as a query or a prompt. An index is a collection of code snippets or documents that contain relevant information for a given programming task or domain. The test case knowledge database 240 is used as a source of additional context and evidence for the LLM, and to integrate the retrieval and generation processes in a seamless way. In various embodiment, a RAG approach may work as follows.

RAG lookup 224 is configured to compare the intent vector against entries within test case knowledge DB 240. Each entry within test case knowledge DB 240 may include a code snippet of the unique existing test case, a title, a description in the natural language describing the unique existing test case, and a semantic coding vector that represents the entry. In one example, the semantic coding vector may be generated from encoding the description within the entry. In another example, the semantic coding vector may be generated from encoding the title and the description. In yet other examples, the semantic coding vector may be generated from encoding other combination of data from the entry. Each entry within test case knowledge DB 240 includes a semantic coding vector that was generated using the same encoding technique. RAG lookup 224 may compare the semantic coding vector of entries within test case knowledge database 240 and the intent vector to identify the top-K matching entries that are most similar to the intent vector. The exact number of entries that are returned from the lookup may depend on implementation details. For example, the number of entries returned may be predefined as the top 5 entries with a semantic coding vector most similar to the intent vector. In another example, all entries that are within a predefined range of the intent vector may be returned. The number of entries returned may vary since it depends on how close the semantic coding vectors are to the intent vector.

Prompt generator 226 receives the top-K entries from RAG lookup 224 and combines the top-K entries with the test intent to generate a prompt. The prompt may in turn be transmitted to LLM 230 where the prompt is used as input to the LLM. In some embodiments, prompt generator 226 may also receive test case methods from method test base database 250. The test case methods may include a library of methods that may be called upon to simplify the coding of the new test case. The library of methods include pre-written software code that the test case can use to perform specific tasks. For example, the test case methods may include a method to retrieve data, a method to print data, or a method to perform calculations. In one example, the test case methods may be stored as a file which is received by prompt generator 226. Prompt generator 226 may in turn include the file as part of the generated prompt. This way, the LLM is aware of existing methods that the LLM may take advantage of when generating new software code. LLM 230 may use the prompt as input and generate output in the form of new code snippet according to some embodiments. The code snippet may be software code to be included as part of the new test case to test code. This may be advantageous because it reduces the amount of time required by a user to create new test cases since the software code for testing the new test case already exists as the code snippet. Once generated, the source code may be transmitted from LLM 230 to test case generator 220. In one embodiment, test case generator 220 may save the new test case having the generated source code as part of test case knowledge database 240. In another embodiment, the generated source code is first reviewed by the user before saving. The new test case with the generated source code may be transmitted to client device 210 to be presented on GUI 212. A user may modify or edit the generated source code until he or she is satisfied with the generated source code. Once satisfied, client device may instruct test case generator 220 to save the new test case, which includes the generated source code that may have been edited or modified by the user. .

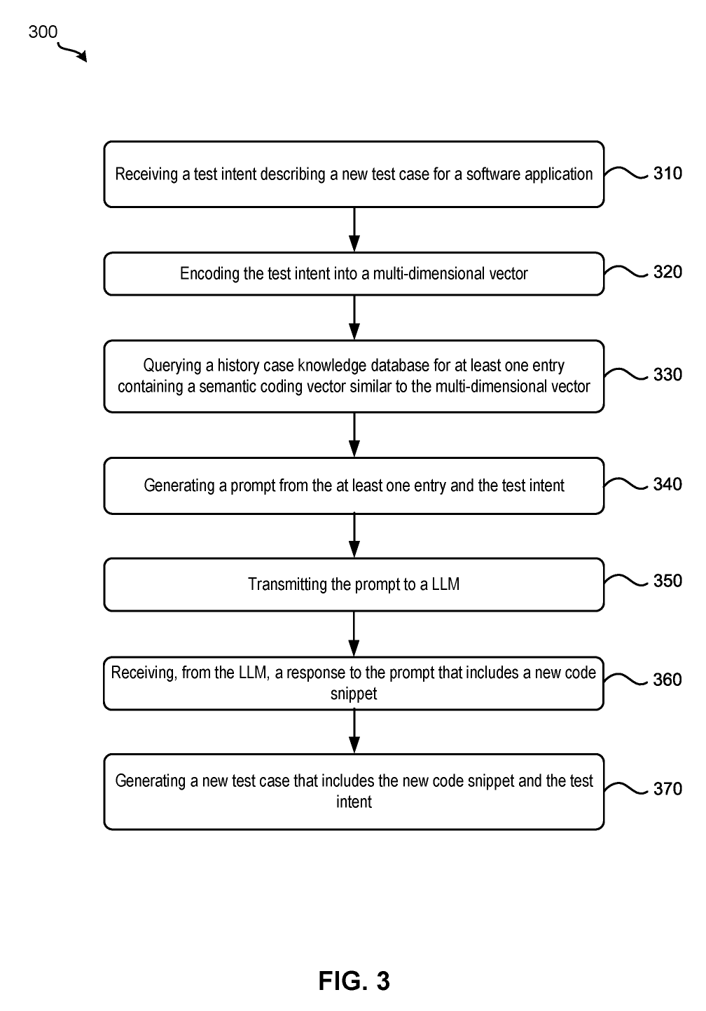

FIG. 3 illustrates a workflow for generating a new test case according to some embodiments. Workflow 300 may be implemented in computer readable code and executed by a processor within a computer system. Workflow can also be implemented in computer readable code and executed by multiple processors within multiple computer systems. In one embodiment, workflow 300 can reside in system 200. Workflow 300 begins by receiving a test intent describing a new test case for a software application at step 310. The test intent may describe a new test case that the user wishes to create and add to an existing test suite containing existing test cases. In one embodiment, the test intent may include a title or name for the new test case and a description of the new test case. The title and description may be in natural language. Advantages of receiving the title and description in natural language include that a user can have minimum or no programming knowledge and still be able to generate a new test case. In one embodiment, the test intent can further include a definition of one or more input parameters for the new test case and/or a definition of a return type for the output of the new test case. Defining the input parameters and return type sets the input and output of the new test case, thereby ensuring that the new test case is aligned with the user’s expectations.

Workflow 300 continues by encoding the test intent into a multi-dimensional vector at step 320. In one embodiment, the description of the test intent is encoded into the multi-dimensional vector, which is also known as the intent vector. In other embodiments, other information within the test intent may be included in the encoding, such as the title, the input parameters, and/or the result type.

Workflow 300 continues by querying a history case knowledge database for at least one entry containing a semantic encoding vector similar to the multi-dimensional vector at step 330. Each entry in the history case knowledge database may be associated with an existing test case. The existing test cases may be part of a test suite or may be part of a library of test cases that the user may select from. In one embodiment, the multi-dimensional vector may be compared against the semantic encoding vectors that correspond to the entries in the history case knowledge database. Each entry in the history case knowledge database may include a semantic encoding vector that was generating using the same encoding technique that was used to generate the multi-dimensional vector. For example, if the multi-dimensional vector was encoded from the description of the test intent, then the semantic coding vector of an entry is generated by encoding the description an existing test case associated with the entry. In one embodiment, the similarity may be measured by calculating the absolute value of the difference between the multi-dimensional vector and the semantic coding vector. The multi-dimensional vector is more similar to the semantic coding vector when the calculated difference is minimal. In one embodiment, a fixed number of entries are queried. For example, the top 5 matches may be returned from the query. In another embodiment, a dynamic number of entries are queried. For example, the entries where the difference between the multi-dimensional vector and the corresponding semantic coding vector is less than a predefined threshold may be returned from the query.

Workflow 300 continues by generating a prompt from the at least one entry and the test intent at step 340. In other embodiments, the prompt may also include other information such as a file containing a library of existing methods to perform specific tasks. Including the file as part of the prompt may provide additional context to the LLM so that it is aware of existing methods that may be called upon when generating the software code. Workflow 300 continues by transmitting the generated prompt to a LLM at step 350. The LLM may process the generated prompt and generate a response. Workflow 300 continues by receiving a response to the prompt that includes a new code snippet at 360. The code snippet may be in in Java. Workflow 300 continues by generating a new test case that involves the new code snippet and the test intent at 370. The new test case may be saved as part of an existing test suite. An entry in history case knowledge database may also be generated for the new test case. Optionally, the new test case may be presented on a graphical user interface of a display for review by the user or developer that submitted the test intent. The user may modify the new test case until he or she is satisfied. Once the user is satisfied with the new test case, then the new test case is saved.

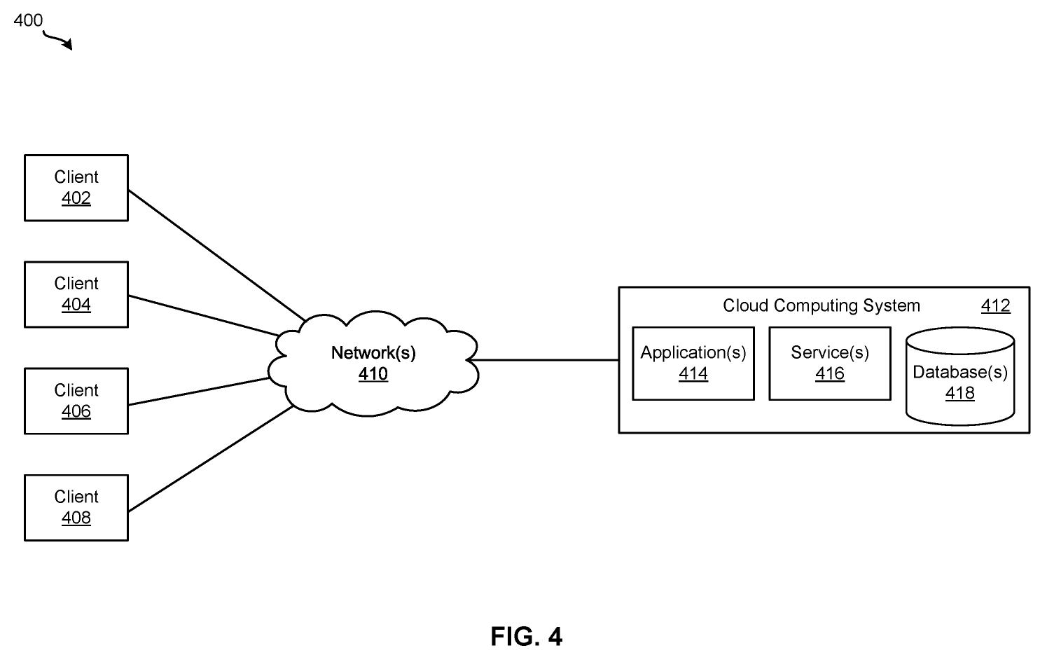

FIG. 4 illustrates an exemplary system 400 for implementing various embodiments described above. For example, cloud computing system 412 may be used to implement computing device 110 and client devices 702-708 may be used to implement client devices utilized to submit customer requests which are transmitted to the cloud computing system 412 via network(s)s 410. As shown, system 400 includes client devices 402-408, one or more networks 410, and cloud computing system 412. Cloud computing system 412 is configured to provide resources and data to client devices 402-408 via networks 410. In some embodiments, cloud computing system 400 provides resources to any number of different users (e.g., customers, tenants, organizations, etc.). Cloud computing system 412 may be implemented by one or more computer systems (e.g., servers), virtual machines operating on a computer system, or a combination thereof.

As shown, cloud computing system 412 includes one or more applications 414, one or more services 416, and one or more databases 418. Cloud computing system 400 may provide applications 414, services 416, and databases 418 to any number of different customers in a self-service, subscription-based, elastically scalable, reliable, highly available, and secure manner. The applications, service, and databases may include the present invention to automatically generate test cases.

In some embodiments, cloud computing system 400 may be adapted to automatically provision, manage, and track a customer's subscriptions to services offered by cloud computing system 400. Cloud computing system 400 may provide cloud services via different deployment models. For example, cloud services may be provided under a public cloud model in which cloud computing system 400 is owned by an organization selling cloud services and the cloud services are made available to the general public or different industry enterprises. As another example, cloud services may be provided under a private cloud model in which cloud computing system 400 is operated solely for a single organization and may provide cloud services for one or more entities within the organization. The cloud services may also be provided under a community cloud model in which cloud computing system 400 and the cloud services provided by cloud computing system 400 are shared by several organizations in a related community. The cloud services may also be provided under a hybrid cloud model, which is a combination of two or more of the aforementioned different models.

In some instances, any one of applications 414, services 416, and databases 418 made available to client devices 402-408 via networks 410 from cloud computing system 412 is referred to as a “cloud service.” Typically, servers and systems that make up cloud computing system 412 are different from the on-premises servers and systems of a customer. For example, cloud computing system 412 may host an application and a user of one of client devices 402-408 may order and use the application via networks 410.

Applications 414 may include software applications that are configured to execute on cloud computing system 412 (e.g., a computer system or a virtual machine operating on a computer system) and be accessed, controlled, managed, etc. via client devices 402-408. In some embodiments, applications 414 may include server applications and/or mid-tier applications (e.g., HTTP (hypertext transport protocol) server applications, FTP (file transfer protocol) server applications, CGI (common gateway interface) server applications, JAVA server applications, etc.). Services 416 are software components, modules, application, etc. that are configured to execute on cloud computing system 412 and provide functionalities to client devices 402-708 via networks 410. Services 416 may be web-based services or on-demand cloud services.

Databases 418 are configured to store and/or manage data that is accessed by applications 414, services 416, and/or client devices 402-708. Databases 418 may reside on a non-transitory storage medium local to (and/or resident in) cloud computing system 412, in a storage-area network (SAN), on a non-transitory storage medium local located remotely from cloud computing system 412. In some embodiments, databases 418 may include relational databases that are managed by a relational database management system (RDBMS). Databases 418 may be a column-oriented databases, row-oriented databases, or a combination thereof. In some embodiments, some or all of databases 418 are in-memory databases. That is, in some such embodiments, data for databases 418 are stored and managed in memory (e.g., random access memory (RAM)).

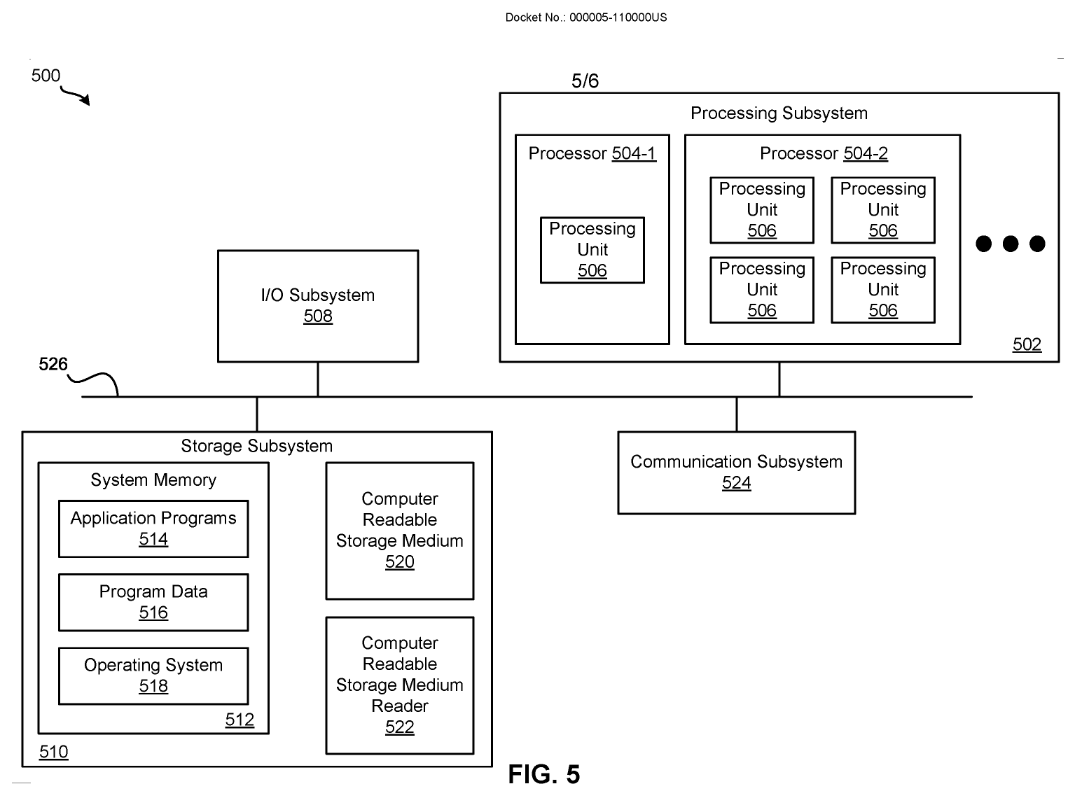

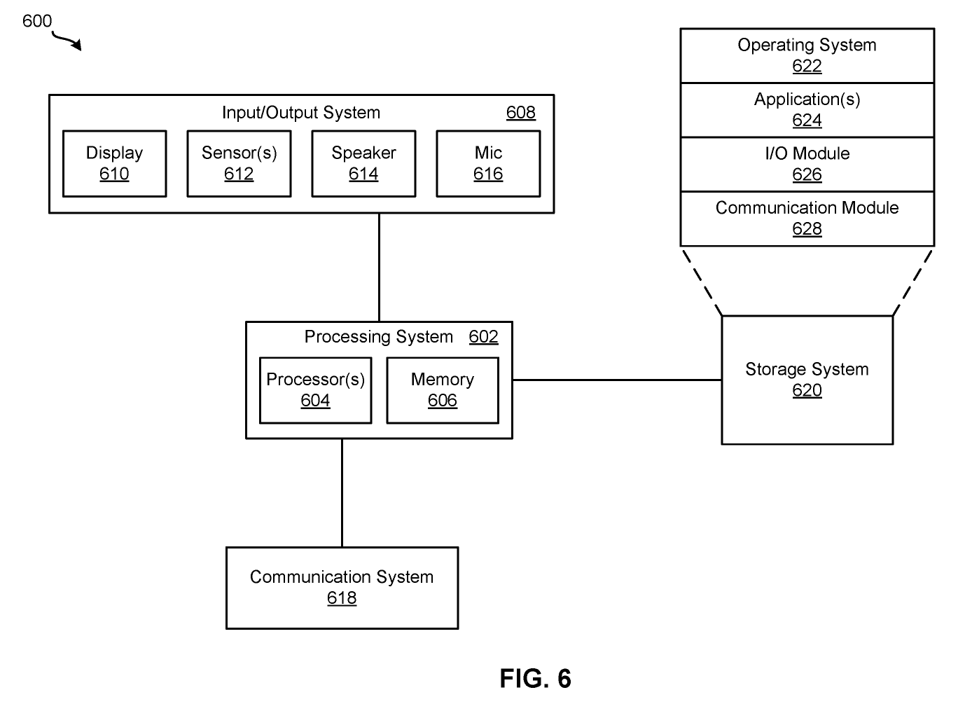

Client devices 402-408 are configured to execute and operate a client application (e.g., a web browser, a proprietary client application, etc.) that communicates with applications 414, services 416, and/or databases 418 via networks 410. This way, client devices 402-408 may access the various functionalities provided by applications 414, services 416, and databases 418 while applications 414, services 416, and databases 418 are operating (e.g., hosted) on cloud computing system 400. Client devices 402-408 may be computer system 500 or computing device 600, as described below by reference to FIGS. 5 and 6, respectively. Although system 400 is shown with four client devices, any number of client devices may be supported.

Networks 410 may be any type of network configured to facilitate data communications among client devices 402-408 and cloud computing system 412 using any of a variety of network protocols. Networks 410 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

FIG. 5 illustrates an exemplary computer system 500 for implementing various embodiments described above. For example, computer system 500 may execute a data query application that retrieves records from the database. The database may be configured as a RBAC model. Computer system 500 may be a desktop computer, a laptop, a server computer, or any other type of computer system or combination thereof. In addition, computer system 500 can implement many of the operations, methods, and/or processes described above (e.g., process 400). As shown in FIG. 5, computer system 500 includes processing subsystem 502, which communicates, via bus subsystem 526, with input/output (I/O) subsystem 508, storage subsystem 510 and communication subsystem 524.

Bus subsystem 526 is configured to facilitate communication among the various components and subsystems of computer system 500. While bus subsystem 526 is illustrated in FIG. 5 as a single bus, one of ordinary skill in the art will understand that bus subsystem 526 may be implemented as multiple buses. Bus subsystem 526 may be any of several types of bus structures (e.g., a memory bus or memory controller, a peripheral bus, a local bus, etc.) using any of a variety of bus architectures. Examples of bus architectures may include an Industry Standard Architecture (ISA) bus, a Micro Channel Architecture (MCA) bus, an Enhanced ISA (EISA) bus, a Video Electronics Standards Association (VESA) local bus, a Peripheral Component Interconnect (PCI) bus, a Universal Serial Bus (USB), etc.

Processing subsystem 502, which can be implemented as one or more integrated circuits (e.g., a conventional microprocessor or microcontroller), controls the operation of computer system 500. Processing subsystem 502 may include one or more processors 504. Each processor 504 may include one processing unit 506 (e.g., a single core processor such as processor 504-1) or several processing units 506 (e.g., a multicore processor such as processor 504-2). In some embodiments, processors 504 of processing subsystem 502 may be implemented as independent processors while, in other embodiments, processors 504 of processing subsystem 502 may be implemented as multiple processors integrate into a single chip or multiple chips. Still, in some embodiments, processors 504 of processing subsystem 502 may be implemented as a combination of independent processors and multiple processors integrated into a single chip or multiple chips.

In some embodiments, processing subsystem 502 can execute a variety of programs or processes in response to program code and can maintain multiple concurrently executing programs or processes. At any given time, some or all of the program code to be executed can reside in processing subsystem 502 and/or in storage subsystem 510. Through suitable programming, processing subsystem 502 can provide various functionalities, such as the functionalities described above by reference to process 800 and process 900.

I/O subsystem 508 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 500 to a user or another device (e.g., a printer).

As illustrated in FIG. 5, storage subsystem 510 includes system memory 512, computer-readable storage medium 520, and computer-readable storage medium reader 522. System memory 512 may be configured to store software in the form of program instructions that are loadable and executable by processing subsystem 502 as well as data generated during the execution of program instructions. In some embodiments, system memory 512 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 512 may include different types of memory, such as static random access memory (SRAM) and/or dynamic random access memory (DRAM). System memory 512 may include a basic input/output system (BIOS), in some embodiments, that is configured to store basic routines to facilitate transferring information between elements within computer system 500 (e.g., during start-up). Such a BIOS may be stored in ROM (e.g., a ROM chip), flash memory, or any other type of memory that may be configured to store the BIOS.

As shown in FIG. 5, system memory 512 includes application programs 514 (e.g., application 115), program data 516, and operating system (OS) 518. OS 518 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 5, and Palm OS, WebOS operating systems.

Computer-readable storage medium 520 may be a non-transitory computer-readable medium configured to store software (e.g., programs, code modules, data constructs, instructions, etc.). Many of the components and/or processes described above may be implemented as software that when executed by a processor or processing unit (e.g., a processor or processing unit of processing subsystem 502) performs the operations of such components and/or processes. Storage subsystem 510 may also store data used for, or generated during, the execution of the software.

Storage subsystem 510 may also include computer-readable storage medium reader 522 that is configured to communicate with computer-readable storage medium 520. Together and, optionally, in combination with system memory 512, computer-readable storage medium 520 may comprehensively represent remote, local, fixed, and/or removable storage devices plus storage media for temporarily and/or more permanently containing, storing, transmitting, and retrieving computer-readable information.

Computer-readable storage medium 520 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSD), flash memory card (e.g., secure digital (SD) cards, CompactFlash cards, etc.), USB flash drives, or any other type of computer-readable storage media or device.

Communication subsystem 524 serves as an interface for receiving data from, and transmitting data to, other devices, computer systems, and networks. For example, communication subsystem 524 may allow computer system 500 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 524 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 524 may provide components configured for wired communication (e.g., Ethernet) in addition to or instead of components configured for wireless communication.

One of ordinary skill in the art will realize that the architecture shown in FIG. 5 is only an example architecture of computer system 500, and that computer system 500 may have additional or fewer components than shown, or a different configuration of components. The various components shown in FIG. 5 may be implemented in hardware, software, firmware or any combination thereof, including one or more signal processing and/or application specific integrated circuits.

FIG. 6 illustrates an exemplary computing device 600 for implementing various embodiments described above. For example, computing device 600 may be used to implement a solution to automatically generate test cases for testing a software application. Computing device 600 may be a cellphone, a smartphone, a wearable device, an activity tracker or manager, a tablet, a personal digital assistant (PDA), a media player, or any other type of mobile computing device or combination thereof. As shown in FIG. 6, computing device 600 includes processing system 602, input/output (I/O) system 608, communication system 618, and storage system 620. These components may be coupled by one or more communication buses or signal lines.

Processing system 602, which can be implemented as one or more integrated circuits (e.g., a conventional microprocessor or microcontroller), controls the operation of computing device 600. As shown, processing system 602 includes one or more processors 604 and memory 606. Processors 604 are configured to run or execute various software and/or sets of instructions stored in memory 606 to perform various functions for computing device 600 and to process data.

Each processor of processors 604 may include one processing unit (e.g., a single core processor) or several processing units (e.g., a multicore processor). In some embodiments, processors 604 of processing system 602 may be implemented as independent processors while, in other embodiments, processors 604 of processing system 602 may be implemented as multiple processors integrate into a single chip. Still, in some embodiments, processors 604 of processing system 602 may be implemented as a combination of independent processors and multiple processors integrated into a single chip.

Memory 606 may be configured to receive and store software (e.g., operating system 622, applications 624, I/O module 626, communication module 628, etc. from storage system 620) in the form of program instructions that are loadable and executable by processors 604 as well as data generated during the execution of program instructions. In some embodiments, memory 606 may include volatile memory (e.g., random access memory (RAM)), non-volatile memory (e.g., read-only memory (ROM), programmable read-only memory (PROM), erasable programmable read-only memory (EPROM), electrically erasable programmable read-only memory (EEPROM), flash memory, etc.), or a combination thereof.

I/O system 608 is responsible for receiving input through various components and providing output through various components. As shown for this example, I/O system 608 includes display 610, one or more sensors 612, speaker 614, and microphone 616. Display 610 is configured to output visual information (e.g., a graphical user interface (GUI) generated and/or rendered by processors 604). In some embodiments, display 610 is a touch screen that is configured to also receive touch-based input. Display 610 may be implemented using liquid crystal display (LCD) technology, light-emitting diode (LED) technology, organic LED (OLED) technology, organic electro luminescence (OEL) technology, or any other type of display technologies. Sensors 612 may include any number of different types of sensors for measuring a physical quantity (e.g., temperature, force, pressure, acceleration, orientation, light, radiation, etc.). Speaker 614 is configured to output audio information and microphone 616 is configured to receive audio input. One of ordinary skill in the art will appreciate that I/O system 608 may include any number of additional, fewer, and/or different components. For instance, I/O system 608 may include a keypad or keyboard for receiving input, a port for transmitting data, receiving data and/or power, and/or communicating with another device or component, an image capture component for capturing photos and/or videos, etc.

Communication system 618 serves as an interface for receiving data from, and transmitting data to, other devices, computer systems, and networks. For example, communication system 618 may allow computing device 600 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication system 618 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication system 618 may provide components configured for wired communication (e.g., Ethernet) in addition to or instead of components configured for wireless communication.

Storage system 620 handles the storage and management of data for computing device 600. Storage system 620 may be implemented by one or more non-transitory machine-readable mediums that are configured to store software (e.g., programs, code modules, data constructs, instructions, etc.) and store data used for, or generated during, the execution of the software.

In this example, storage system 620 includes operating system 622, one or more applications 624, I/O module 626, and communication module 628. Operating system 622 includes various procedures, sets of instructions, software components and/or drivers for controlling and managing general system tasks (e.g., memory management, storage device control, power management, etc.) and facilitates communication between various hardware and software components. Operating system 622 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Applications 624 can include any number of different applications installed on computing device 600. Examples of such applications may include a browser application, an address book application, a contact list application, an email application, an instant messaging application, a word processing application, JAVA-enabled applications, an encryption application, a digital rights management application, a voice recognition application, location determination application, a mapping application, a music player application, etc.

I/O module 626 manages information received via input components (e.g., display 610, sensors 612, and microphone 616) and information to be outputted via output components (e.g., display 610 and speaker 614). Communication module 628 facilitates communication with other devices via communication system 618 and includes various software components for handling data received from communication system 618.

One of ordinary skill in the art will realize that the architecture shown in FIG. 6 is only an example architecture of computing device 600, and that computing device 600 may have additional or fewer components than shown, or a different configuration of components. The various components shown in FIG. 6 may be implemented in hardware, software, firmware or any combination thereof, including one or more signal processing and/or application specific integrated circuits.

The above description illustrates various embodiments of the present disclosure along with examples of how aspects of the present disclosure may be implemented. The above examples and embodiments should not be deemed to be the only embodiments, and are presented to illustrate the flexibility and advantages of various embodiments of the present disclosure as defined by the following claims. Based on the above disclosure and the following claims, other arrangements, embodiments, implementations and equivalents will be evident to those skilled in the art and may be employed without departing from the spirit and scope of the present disclosure as defined by the claims.

What is claimed is:

1. A non-transitory machine-readable medium storing a program executable by at least one processing unit of a device, the program comprising sets of instructions for:
receiving, in a user prompt of a graphical user interface, a test intent in a natural language describing a new test case for a software application;
encoding the test intent into a multi-dimensional vector;
querying a history case knowledge database containing a plurality of entries to receive at least one entry, wherein each entry in the plurality of entries is associated with a unique existing test case and includes a code snippet of the unique existing test case, a description in the natural language describing the unique existing test case, and a semantic coding vector representing the description, and wherein the semantic coding vector in each of the at least one entry is similar to the multi-dimensional vector;
generating a prompt from the at least one entry and the test intent;
transmitting the prompt to a Large Language Model (LLM);
receiving, from the LLM, a response to the prompt, wherein the response includes a new code snippet; and
generating a new test case that includes the new code snippet and the test intent.

2. The non-transitory machine-readable medium of claim 1, further comprising:
presenting the new test case on the graphical user interface;
receiving, in the graphical user interface, an indication that the new test case is accepted; and
adding the new test case to a test case database.

3. The non-transitory machine-readable medium of claim 2, further comprising:
generating a new entry based on the new test case; and
adding the new entry to the history case knowledge database.

4. The non-transitory machine-readable medium of claim 3, wherein generating the new entry includes generating a new semantic coding vector from the test intent.

5. The non-transitory machine-readable medium of claim 1, wherein the test intent includes a new name for the new test case and a new description of the new test case.

6. The non-transitory machine-readable medium of claim 5, wherein embedding the test intent into a multi-dimensional vector includes embedding the new description into the multi-dimensional vector.

7. The non-transitory machine-readable medium of claim 5, wherein the prompt includes the new description, the at least one entry, and the description in natural language from the plurality of entries.

8. The non-transitory machine-readable medium of claim 7, wherein the prompt further includes a file containing a library of existing methods to perform specific tasks, wherein the new code snippet calls upon an existing method from the library of existing methods.

9. A method comprising:
receiving, in a user prompt of a graphical user interface, a test intent in a natural language describing a new test case for a software application;
encoding the test intent into a multi-dimensional vector;
querying a history case knowledge database containing a plurality of entries to receive at least one entry, wherein each entry in the plurality of entries is associated with a unique existing test case and includes a code snippet of the unique existing test case, a description in the natural language describing the unique existing test case, and a semantic coding vector representing the description, and wherein the semantic coding vector in each of the at least one entry is similar to the multi-dimensional vector;
generating a prompt from the at least one entry and the test intent;
transmitting the prompt to a Large Language Model (LLM);
receiving, from the LLM, a response to the prompt, wherein the response includes a new code snippet; and
generating a new test case that includes the new code snippet and the test intent.

10. The method of claim 9, further comprising:
presenting the new test case on the graphical user interface;
receiving, in the graphical user interface, an indication that the new test case is accepted; and
adding the new test case to a test case database.

11. The method of claim 10, further comprising:
generating a new entry based on the new test case; and
adding the new entry to the history case knowledge database.

12. The method of claim 11, wherein generating the new entry includes generating a new semantic coding vector from the test intent.

13. The method of claim 9, wherein the test intent includes a new name for the new test case and a new description of the new test case.

14. The method of claim 13, wherein embedding the test intent into a multi-dimensional vector includes embedding the new description into the multi-dimensional vector.

15. The method of claim 13, wherein the prompt includes the new description, the at least one entry, and the description in natural language from the plurality of entries.

16. The method of claim 15, wherein the prompt further includes a file containing a library of existing methods to perform specific tasks, wherein the new code snippet calls upon an existing method from the library of existing methods.

17. A system comprising:
a set of processing units; and
a non-transitory machine-readable medium storing instructions that when executed by at least one processing unit in the set of processing units cause the at least one processing unit to:
receive, in a user prompt of a graphical user interface, a test intent in a natural language describing a new test case for a software application;
encode the test intent into a multi-dimensional vector;
query a history case knowledge database containing a plurality of entries to receive at least one entry, wherein each entry in the plurality of entries is associated with a unique existing test case and includes a code snippet of the unique existing test case, a description in the natural language describing the unique existing test case, and a semantic coding vector representing the description, and wherein the semantic coding vector in each of the at least one entry is similar to the multi-dimensional vector;
generate a prompt from the at least one entry and the test intent;
transmit the prompt to a Large Language Model (LLM);
receive, from the LLM, a response to the prompt, wherein the response includes a new code snippet; and
generate a new test case that includes the new code snippet and the test intent.

18. The system of claim 17, wherein the instructions that when executed by the at least one processing unit in the set of processing units further cause the at least one processing unit to:
present the new test case on the graphical user interface;
receive, in the graphical user interface, an indication that the new test case is accepted; and
add the new test case to a test case database.

19. The system of claim 18, wherein the instructions that when executed by the at least one processing unit in the set of processing units further cause the at least one processing unit to:
generate a new entry based on the new test case; and
add the new entry to the history case knowledge database.

20. The system of claim 19, wherein generating the new entry includes generating a new semantic coding vector from the test intent.
